(19) United States
(12) Patent Application Publication
(10) Pub. No.: US 2020/0040963 A1
(43) Pub. Date: Feb. 6, 2020

(54) FLYWHEEL WITH VARIABLE MOMENT OF INERTIA

(71) Applicant: Ford Global Technologies, LLC, Dearborn, MI (US)

(72) Inventors: Guenter Hans Grosch, Vettweiss (DE); Rainer Lach, Wuerselen (DE)

(21) Appl. No.: 16/532,314

(22) Filed: Aug. 5, 2019

(30) Foreign Application Priority Data
Aug. 6, 2018 (DE) 102018213093.0

(51) Int. Cl. F16F 15/31; F16F 15/14

(52) U.S. Cl. CPC F16F 15/31; F16F 15/1485

(57) ABSTRACT

Methods and systems are provided for a variable inertia flywheel. In one example, a method adjusting mass bodies of two or more inertia plates of the variable inertia flywheel to generate a plurality of moments of inertia.

### CROSS REFERENCE TO RELATED APPLICATION

The present application claims priority to German patent application No. 102018213093.0, filed on Aug. 6, 2018. The entire contents of the above-listed application are hereby incorporated by reference for all purposes.

### FIELD

The present description relates generally to methods and systems for a variable inertia flywheel.

### BACKGROUND

### SUMMARY

Vehicles may include a flywheel between engine and clutch which can reduce engine pulsations. The flywheel may improve noise, vibration and harshness (NVH) as well as improving smoothness of acceleration and aiding in braking recuperation. Flywheels (single mass and dual mass flywheels) may have an inertia that is dependent on respective rotations per minute (rpm). Variable mass flywheels, where masses may move, can allow a more graduated adjustment of the moment of inertia for the flywheel than single and dual mass flywheels. It is desirable to have a flywheel with variable inertia to more fully compensate for pulsations in the vehicle drivetrain. A heavier flywheel can increase traction for braking and can improve engine fluctuations. At higher speeds, a lighter flywheel can aide in acceleration. Variable mass flywheels are known but have limitations such as large size or being excessively complicated.

One example approach is shown by Lorenz et al. in U.S. Patent Publication No. 2015247551 A1, therein a variable mass inertial flywheel is described for torsional damping. In this case, there are movable masses that can change the moment of inertia of the flywheel. The flywheel is also comprised of a number of rotatable mass rings but none of these rings can rotate independently of each other, limiting the graduation of the inertia. Based on the abovementioned disadvantages of the prior variable mass flywheels, the inventors herein have developed a flywheel that is comprised of rotatable mass rings, with adjustable masses, that can operate independently of each other, further expanding the possible inertial states for the flywheel.

In one example, the issues described above may be addressed by a flywheel comprising a disk flywheel and at least two inertial mass rings, including a first mass ring and a second mass ring arranged radially offset with respect to one another and are rotatably mounted and that rotate around a rotation axis, further comprising a first braking apparatus for selectively coupling the first mass ring to the disk flywheel and a second braking apparatus for selectively coupling the second mass ring to the disk flywheel. In this way, a graded moment of inertia of the disk flywheel may be realized.

As one example, the first mass ring or the second mass ring may be engaged with the disk flywheel based on a rotational speed of the disk flywheel. While engaged, the mass bodies of the first mass ring or the second mass ring may be operated individually to achieve a plurality of moments of inertia. By doing this, power output and fuel economy may be enhanced while ride comfort may also be improved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure. Advantages and features of the present description will be apparent from the detailed description to follow, either taken alone or in conjunction with the accompanying figures shown below. It should be known that the description above is intended to introduce in a simplified matter a number of concepts that are described further in the detailed description. This summary is not intended to elucidate key features of the claimed subject material, the scope of which is defined uniquely by the claims that follow the detailed description. In addition, the claimed subject matter is not limited to implementations that solve any disadvantages noted above or in any part of this disclosure.

### BRIEF DESCRIPTION OF THE DRAWINGS

FIG. 1 schematically shows a disk flywheel with a high moment of inertia of a previous example.

FIG. 2 schematically shows a disk flywheel with a low moment of inertia of a previous example.

FIG. 3 schematically shows a first variant of a flywheel.

FIG. 4 schematically shows a second variant of a flywheel.

FIG. 5 schematically shows a recuperation braking arrangement.

FIG. 6 schematically shows a drive arrangement.

FIG. 7 schematically shows a motor vehicle.

FIG. 8 illustrates a schematic of an engine included in a hybrid vehicle.

### DETAILED DESCRIPTION

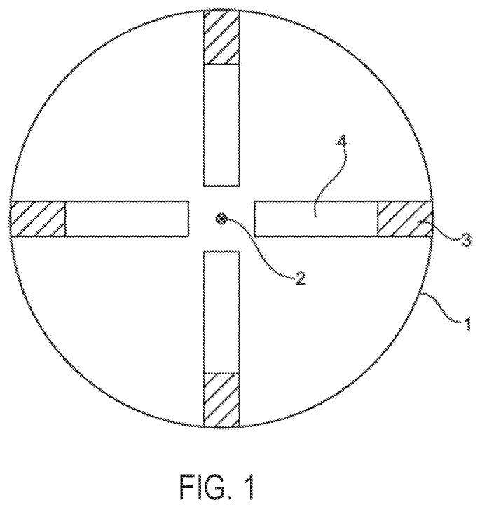

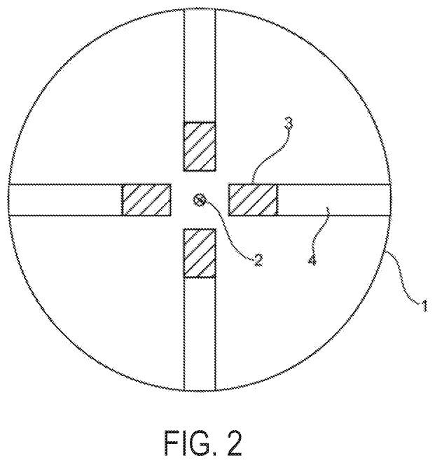

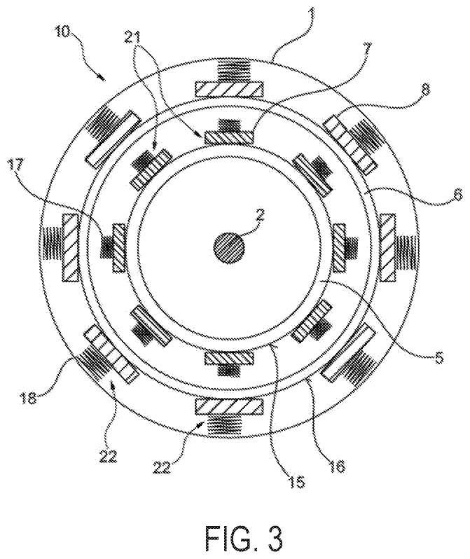

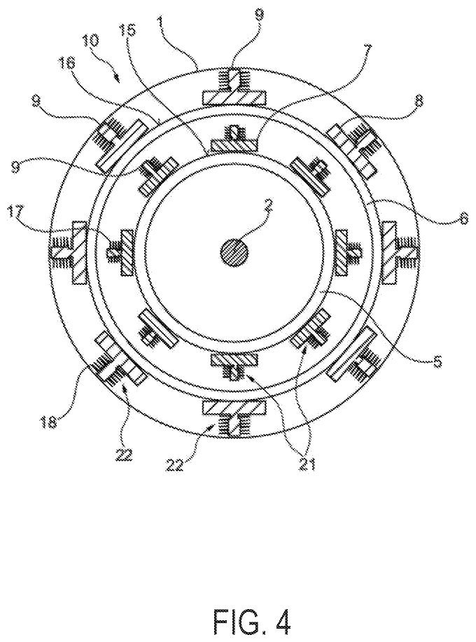

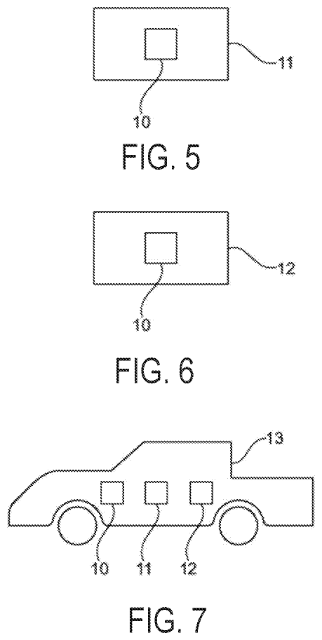

The following description relates to systems and methods for a flywheel. In one example, the flywheel comprises a rotational axis, at least one disk flywheel and at least two inertial mass rings which are arranged radially offset with respect to one another and rotatably mounted, as shown in FIGS. 3 and 4. For each inertial mass ring, a number of braking apparatuses, for example brake pads, may be fixedly connected to the disk flywheel. The brake apparatuses may be configured for a detachable connection to the inertial mass ring. The flywheel has the advantage that several inertial mass rings are provided which can be connected to the disk flywheel or detached from it independently of each other. In this manner, a graduated adjustment of the inertial moment of the disk flywheel is possible, relative to the previous examples illustrated in FIGS. 1 and 2. As a result of this, smoother braking or acceleration can be realized, resulting in greater customer satisfaction and ride comfort. The number of possible stages of the inertial moment can be increased individually, for example, via the number of inertial mass rings used. In particular, three or more inertial mass rings can also be provided. FIGS. 5, 6, 7, and 8 illustrate various arrangements in which the flywheel may be included.

In one example, the braking apparatuses comprise at least one brake pad, at least one spring and at least one mass body. The detachable connection to the inertial mass ring is brought about in the form of a frictionally engaged connection in that at least one mass body pushes at least one brake pad against the inertial mass ring via the at least one spring. Then, at least one mass body is arranged displaceably against the spring, radially, in relation to the rotational axis of the flywheel so that the spring is compressed as a function of the rotational speed and the frictionally engaged connection is detached as a result.

The rotational speed, in the case of which the respective inertial mass ring is connected fixedly to the disk flywheel or detached therefrom, can be influenced and controlled by the mass of the mass bodies and by the spring constant of the springs used. In particular, individual inertial mass rings can be connected to braking apparatuses which comprise in each case mass bodies with masses which deviate from one another for each inertial mass ring and/or springs with spring constants which deviate from one another. At least one inertial mass ring can comprise a circumferential surface. The brake pads, such as the brake pads corresponding to the respective inertial mass ring, for example, can be arranged so that they are pushed via the springs radially from the outside against the circumferential surface of the inertial mass ring.

In another example, a first inertial mass ring can be connected in a frictionally engaged manner to a number of braking apparatuses, to be specific, the brake pads. The braking apparatuses comprise in each case mass bodies with a first mass mi. A second inertial mass ring can be connected in a frictionally engaged manner to a number of braking apparatuses, wherein these braking apparatuses comprise in each case mass bodies with a second mass m₂. Masses m₁ and m₂ differ from one another here. For example, mass m₁ can be larger than mass m₂ . The use of mass bodies with masses which deviate from one another for each inertial mass ring has the advantage that the respective inertial mass rings are detached from the disk flywheel in the case of rotational speeds which deviate from one another and thus, in a graduated form, contribute to the torque of the disk flywheel.

In addition or alternatively to the example described above, a first inertial mass ring can be connected in a frictionally engaged manner to a number of braking apparatuses, wherein the braking apparatuses comprise in each case springs with a first spring constant Di. A second inertial mass ring can be connected in a frictionally engaged manner to a number of braking apparatuses which comprise in each case springs with a second spring constant D₂. Spring constant D₁ and D₂ differ from one another. Spring constant D₁ is, for example, greater than spring constant D₂. The different configuration of the spring constants also brings about, just like a different configuration of the masses of the mass bodies, a connection of the respective inertial mass ring to the disk flywheel and thus a detachment from the disk flywheel in the case of different rotational speeds. A graduated moment of inertia of the disk flywheel can thus be realized via spring constants configured in a graduated manner, in addition or alternatively to masses configured in a graduated manner for each inertial mass ring.

As a result of the described variants, a flywheel with three or more moment of inertia stages can be realized. For example, the flywheel can comprise a first inertial mass ring which can be connected with a number of braking apparatuses to mass bodies with a first mass m₁ and/or to springs with a first spring constant D₁. A second inertial mass ring can be connected with a number of braking apparatuses to mass bodies with a second mass m₂ and/or to springs with a second spring constant D₂. A third inertial mass ring can be connected with a number of braking apparatuses to mass bodies with a third mass m₃ and/or to springs with a third spring constant D₃. Masses m₁, m₂, m₃ are preferably different from one another. In addition or alternatively to this, spring constants D₁, D₂, D₃ are also different. In this manner, individual graduation, which can be continued as desired, can be realized.

In a further example, the braking apparatuses can comprise in each case at least one mass body and the detachable connection to the inertial mass ring can be brought about in the form of a frictionally engaged connection in that at least one mass body pushes a brake pad against the inertial mass ring via a spring fastened to the disk flywheel, wherein in each case the at least one mass body is arranged radially displaceably against the spring via an actuator so that the spring is compressed by the mass body and the frictional connection is detached. The use of an actuator for displacement of the mass bodies against the springs also enables, as an alternative or in addition to a rotational speed-dependent connection between the inertial mass ring and disk flywheel, a rotational speed-independent control of the moment of inertia of the disk flywheel by virtue of the fact that the mass bodies can also be displaced independently of the rotational speed and thus a connection between inertial mass ring and disk flywheel can be produced or detached.

The actuator can, for example, be configured to be hydraulically controllable. A hydraulic activation can be realized, for example, in the bearing of a crankshaft in that an annular groove located next to the bearing lubrication in the bearing of the crankshaft is supplied via a separate oil duct and is regulated via a solenoid valve. The pressurized oil proceeds from there into a crankshaft flange and into the flywheel, where it can be conducted via ducts to the adjusters of the movable mass. In this case, the oil works against the springs and can thus displace the mass bodies.

In a further example, at least one inertial mass ring, for example, all the inertial mass rings present, can be connected electromagnetically to the braking apparatuses and thus to the flywheel. In this variant, it can, for example, be determined via a control unit when the inertial mass rings should co-rotate and when they should be uncoupled. This has the advantage, for example, in the case of hybrid vehicles that, with activated recuperation, braking of the vehicle can occur more gently since the inertia can be reduced and thus more torque can be transmitted to the generator without the vehicle slowing down excessively. The individual inertial mass rings can be configured to be in each case individually electromagnetically controllable.

The vehicle comprises a flywheel already described and/or a recuperation braking arrangement and/or a drive arrangement. The vehicle can be a motor vehicle, a ship, a heavy goods vehicle, a motor bike, or a bus. The vehicle can be configured in particular as a hybrid motor vehicle.

In the context of braking and drive processes of a vehicle, the present flywheel has the advantage that the moment of inertia of the flywheel can be controlled individually and in a targeted manner in particular in the context of start-stop functions. For example, in the case of a braking operation, mass can be activated, and an inertial mass ring or several inertial mass rings can therefore be coupled to the disk flywheel, and once the mass or the corresponding inertial mass ring has reached a corresponding rotational speed, this can be uncoupled. During starting or in the case of an acceleration process, the rotating mass or the corresponding inertial mass ring can be activated or coupled again and thus the starting and acceleration process can be supported.

FIGS. 1 and 2 show disk flywheels 1 that have a rotational axis 2 and in the example shown in each case four, mass bodies 3. Mass bodies 3 are arranged radially and displaceably, for example, within corresponding guide rails 4. In the example shown in FIG. 1, mass bodies 3 are arranged radially on the outside. Disk flywheel 1 thus has a high moment of inertia. In FIG. 2, mass bodies 3 are arranged radially on the inside. Disk flywheel 1 thus has a low moment of inertia in comparison with the variant shown in FIG. 1. Via a displacement of mass bodies 3 from the inside to the outside or along guide rails 4 in the radial direction to the outside, the moment of inertia can be increased or reduced.

Thus, in one example, by adjusting the radially position of the mass bodies 3 along the guide rails 4, a moment of inertia of the disk flywheels 1 may be adjusted. By moving the mass bodies 3 to an inner radial position, such as the position illustrated in FIG. 2, the moment of inertia may be relatively low compared to an outer radial position, such as the position illustrated in FIG. 1. By doing this, a moment of inertia may be fine-tuned to a desired moment of inertia.

A first example of a flywheel is shown schematically in FIG. 3. Flywheel 10 comprises a disk flywheel 1 and two or more inertial mass rings. In the variant shown, a first inertial mass ring 5 is arranged radially inside a second radial inertial mass ring 6. First inertial mass ring 5 comprises a circumferential surface 15 and second inertial mass ring 6 comprises a circumferential surface 16. That is to say, the first inertial mass ring 5 is positioned radially interior to the second inertial mass ring 6.

A number of braking apparatuses 21, 22 for detachable connection of inertial mass rings 5 and 6 to disk flywheel 1 are fastened to disk flywheel 1. In this case, braking apparatus 21 is configured for braking and frictionally engaged connection of first inertial mass ring 5 to disk flywheel 1 and braking apparatus 22 is configured for braking and frictionally engaged connection of second inertial mass ring 6 to disk flywheel 1. In the variant shown, brake pads which comprise mass bodies 7 and 8 are pushed radially from the outside against outer surfaces 15 and 16 via springs 17 and 18. In the case of an increasing rotational speed of disk flywheel 1, mass bodies 7 and 8 are pushed radially to the outside against springs 17 and 18. As a result of this, the brake pads or mass bodies 8 and 7 detach from respective surfaces 15 and 16 with the consequence that respective inertial mass rings 5 and 6 rotate freely and thus no longer represent inertia or no longer contribute to the moment of inertia of disk flywheel 1.

In the example shown in FIG. 3, mass bodies 7 have a smaller (e.g., lower) mass than mass bodies 8. In the case of an increasing rotational speed of disk flywheel 1, first inertial mass ring 5 would thus firstly become detached from the disk flywheel 1 and in the case of a higher rotational speed also second inertial mass ring 6. Thus, in one example, if the flywheel speed is increasing, then the first inertial mass ring 5 may be detached when its moment of inertia is too low and the flywheel speed is fast enough to efficiently spin the second inertial mass ring 6 without a reduction in engine power. If the rotational speed of the flywheel ring continues to increase beyond a moment of inertia of the second inertial mass ring 6, then the second inertial mass ring 6 may be decoupled. In one example, decoupling the first and second inertial mass rings comprises allowing the mass rings to rotate freely of the disk flywheel 1. If the rotational speed drops again, the centrifugal force of mass bodies 7 and 8 is surpassed by the spring force of springs 17 and 18 and inertial mass rings 5 and 6 are again coupled to disk flywheel 1 and accelerate it. In the variant shown in FIG. 3, initially second inertial mass ring 6 and in the case of an even lower rotational speed first inertial mass ring 5 is coupled to disk flywheel 1. Since the centrifugal force is also dependent on the radius on which the mass is located, the outer ring would detach first in the case of the same spring constant and same mass. First springs 17 and second springs 18 can have spring constants which deviate from one another. In this case, mass bodies 7 and 8 can also have identical masses and the rotational speed for coupling and uncoupling inertial mass rings 5 and 6 to disk flywheel 1 can be determined or fixed via the respective spring constants.

Turning now to FIG. 4, actuators 9 are arranged on springs 17 and 18 and/or on mass bodies 7 and 8. Mass bodies 7 and 8 can be pushed against springs 17 and 18 and/or springs 17 and 18 can be directly compressed via actuators 9. In this manner, a rotational speed-independent, graduated moment of inertia of disk flywheel 1 can be realized. Actuators 9 can be configured, for example, to be hydraulically controllable. In a further example, inertial mass rings 5 and 6 can be coupled electromagnetically to disk flywheel 1. This likewise enables individual control of the moment of inertia.

In one example, the flywheel 10 comprises a disk flywheel 1 and a first mass ring 5 and a second mass ring 6. Each of the disk flywheel 1, first mass ring 5, and second mass ring 6 may rotate about the rotational axis 2. In one example, the rotational axis 2 may correspond to a rotational axis of a crankshaft. Furthermore, the disk flywheel 1 and the first mass ring 5 and the second mass ring 6 may be arranged on the crankshaft such that rotation of the crankshaft results in rotation of the disk flywheel and the first and second mass rings.

The first mass ring 5 may comprise a plurality of mass bodies 7 symmetrically arranged about the rotational axis 2. In the example shown, the first mass ring 5 comprises an even number of mass bodies 7. However, it will be appreciated that the first mass ring 5 may comprise an odd number of mass bodies 7 also arranged symmetrically about the rotational axis 2.

The second mass ring 6 may comprise a plurality of mass bodies 8 symmetrically arranged about the rotational axis 2. In the example shown, the second mass ring comprises an even number of mass bodies 8, wherein a number of mass bodies 8 is equal to the number of mass bodies 7. However, it will be appreciated that the second mass ring 6 may comprise an odd number of mass bodies 8 arranged symmetrically about the rotational axis 2. Additionally or alternatively, a number of mass bodies 8 may be greater than or less than a number of mass bodies 7.

The mass bodies 7, 8 may be equal in size and shape. Additionally or alternatively, the mass bodies 7, 8 may be different in size and/or shape. The mass bodies 7 may be physically coupled to first springs 17, wherein each mass body of the mass bodies 17 is physically coupled to an individual spring of the springs 17. Similarly, the mass bodies 8 may be physically coupled to second springs 18, wherein each mass body of the mass bodies 8 is physically coupled to an individual spring of the springs 18.

In one example, to accommodate for the varying centrifugal forces between the mass bodies 7 (herein, first mass bodies 7) and the mass bodies 8 (herein, second mass bodies 8), the first springs 17 and the second springs 18 may comprise different spring constants to force desired coupling and decoupling of the first mass ring 5 and the second mass ring 6. In one example, the spring constant of the second springs 18 may be greater than the spring constant of the first springs 17 to account for greater centrifugal forces at the second mass ring 6 due to the radial positioning of the second mass bodies 8 relative to the first mass bodies 7. As such, the first and second springs 17, 18 may push the mass bodies radially inward toward the rotational axis 2. As the mass plates increase in speed, their respective mass bodies may begin to push radially outward with an increased centrifugal force, such that the springs compress. The mass bodies may move to a radially outermost position in response to a specific angular and/or rotational velocity such that first or second brake pads 21, 22 are released and the mass plate is free to rotate independently of the disc flywheel 1.

Additionally or alternatively, the actuators 9 may be arranged on first and second springs 17, 18 or first and second mass bodies 7, 8. The actuators 9 may provide a supplemental force against or with the first and second springs 17, 18. In one example, the actuators 9 may be activated via a hydraulic fluid, such as oil. In this way, the actuators 9 may comprise a first chamber wherein hydraulic fluid may enter and press against the springs and a second chamber where hydraulic fluid may enter to press with the springs. A pressure of the hydraulic fluid may combine with a current centrifugal force to increase a force acting against the spring or with a spring force to increase a force against the centrifugal force.

In some examples, the hydraulic fluid may be controlled such that a flow to each individual actuator may be adjusted. As such, in some examples, a single actuator may receive hydraulic fluid while the remaining actuators may be free of hydraulic fluid. In this way, the disc flywheel may experience a plurality of moments of inertia, as a radial position of each individual mass may be adjusted to a desired radial location. However, in some examples, to balance a rotation of the mass plates 5, 6, the actuators may be adjusted in pairs, wherein a pair of actuators includes actuators diametrically across from one another and corresponding to the same mass plate. For example, a pair of actuators of the first mass plate 5 may not include actuators of the second mass plate 6. The pair may further include actuators diametrically across from one another such that a symmetry of the mass plate is maintained.

In this way, the actuators may allow a desired moment of inertia to be fixed. For example, if the disc flywheel 1 is accelerating and the first brake pads 21 are engaged so that the first mass plate 5 is coupled to the disc flywheel 1, then the first mass bodies may move to an outer position against a force of the spring. However, hydraulic flow in and out of the first and second chambers may be adjusted such that a moment of inertia is fixed by balancing the centrifugal and spring forces via hydraulic fluid flow. In the case of accelerating the disc flywheel, hydraulic flow to the second chamber may be adjusted to balance the force of the spring and hydraulic fluid against the centrifugal force to realize a fixed, desired moment of inertia. However, if it is desired for the moment of inertia to increase, then the hydraulic fluid may move from the second, outer chamber to the first, inner chamber as the mass bodies move radially outward. Thus, if it is desired for the moment of inertia to decrease, such as during a braking event, then the hydraulic fluid may move from the first inner chambers to the second outer chambers as the mass bodies move radially inward.

In this way, by adjusting the first and second brake pads 21, 22, a coupling between the disc flywheel and the first mass plate 5 and the second mass plate 6 may be adjusted. Various moments of inertia may be realized by coupling none, one, or both of the first mass plate 5 and the second mass plate 6 to the disc flywheel 1. Additionally or alternatively, mass bodies of the first mass plate 5 and the second mass plate 6 may be individually actuated, if desired, to further realize additional moments of inertia. By doing this, a drive comfort may be increased and customer satisfaction may be increased. Additionally or alternatively, fuel economy and vehicle power output may be enhanced as moments of inertia may be more closely matched to the disc flywheel rotational speed.

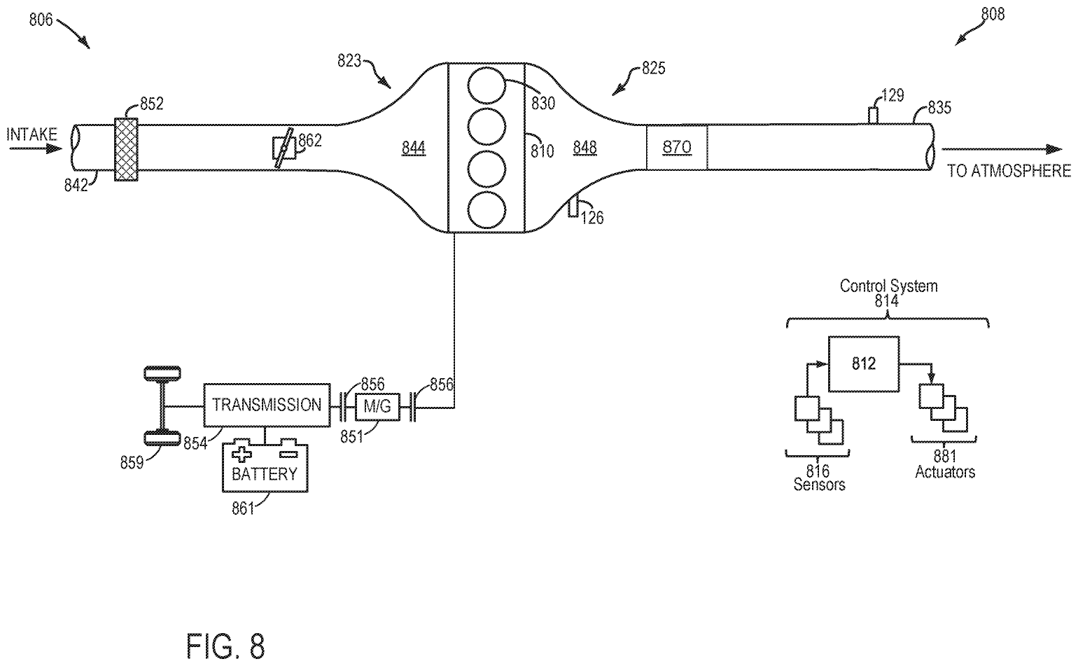

FIG. 5 schematically shows a recuperation braking arrangement 11. Recuperation braking arrangement 11 comprises a flywheel 10 as described above. The flywheel 10 may comprise a coil or other similar device embedded in the disc flywheel that rotates along with the disc flywheel in a magnetic field. The induced electromagnetic current may be used to recharge a battery, such as battery 861 of FIG. 8.

Furthermore, in some examples, additionally or alternatively, actuators of the mass bodies may be magnetically actuated. By doing this, as the vehicle decelerates and the inertia is reduced via the mass bodies moving radially inward, more power may be transferred to a generator, which may increase a state of charge of the battery.

FIG. 6 schematically shows a drive arrangement 12. Drive arrangement 12 comprises a flywheel 10 as described above. Recuperation braking arrangement 11 and drive arrangement 12 have the advantage that they have a torque which can be controlled in a graduated manner.

FIG. 7 shows a motor vehicle 13. Motor vehicle 13 comprises a recuperation braking arrangement 11 described above and/or a drive arrangement 12 as described above and/or a flywheel 10 as described above.

As such, the flywheel 10 of FIGS. 3 through 7 may be used to assist in the deceleration (e.g., braking) and acceleration of a vehicle. During the deceleration, the mass plates may be coupled to the disc flywheel to until the disc flywheel reaches a target speed, wherein the mass plates may be decoupled. In one example, the moment of inertia may be gradually adjusted via adjusting the second mass plate, wherein the mass bodies are gradually moved radially inward to decrease the moment of inertia as the vehicle slows. Once the disc flywheel reaches a first target speed, the second mass plate may be decoupled and the first mass plate may be coupled, wherein the first mass bodies being to move gradually radially inward to decrease the moment of inertia. By doing this, waste heat lost due to friction brakes may be reduced, and more energy may be conserved, in the form of kinetic energy transferred to the disc flywheel or to recharge a battery or to power an auxiliary device. The second mass plate may be decoupled in response to the disc flywheel reaching a second target speed, higher than the first target speed, in one example.

The first and second mass plates may also be used to assist the vehicle out of a stop. In one example, the stop may be part of a start/stop feature of the vehicle. As such, prior to the stop, the vehicle may utilize the decreasing moment of inertia procedure described above. During the engine restart in response to a request to accelerate the vehicle out of the stop, the moment of inertia may be gradually increased by first coupling the first mass plate to the disc flywheel, wherein the first mass bodies are gradually adjusted to radially outer positions from a radially innermost position as the speed of the disc flywheel increases. Once the first mass plate reaches its highest moment of inertia, the first mass plate may be decoupled (e.g., disengaged) in response to the disc flywheel reaching a first target speed, and the second mass plate may be coupled (e.g., engaged with the disc flywheel), wherein the second mass bodies of the disc flywheel are adjusted to radially outer positions from as the disc flywheel accelerates. The second mass bodies may move to a radially outermost position and the second mass plate may be decoupled (e.g., disengaged) in response to the disc flywheel reaching a second target speed.

As described above, when the first and second mass plates are disengaged, the first and second weights may be in radially outermost positions. Additionally, brakes may be released so that the first and second mass plates are no longer coupled to the disc flywheel. As such, the first and second mass plates may rotate freely of one another and of the disc flywheel.

As a real-world example, at a start of an engine, the plurality of first mass bodies may be positioned in a radially innermost position corresponding to a lowest moment of inertia. As the engine is accelerated, the low moment of inertia of the disk flywheel via the first mass inertia plate may allow the disk flywheel to be less resistant to changes in angular velocity, thereby increasing an acceleration response of the engine, resulting in increased engine power output and improved fuel economy. Additionally, the first mass inertia plate may transfer stored kinetic energy from a previous braking event or other event to the flywheel, further assisting its acceleration and improving fuel economy. As the disk flywheel accelerates, its angular velocity may be compared to a first target speed based on feedback from a crankshaft position sensor or via data stored in a multi-input look-up table wherein inputs include spring constants, mass body weights and outputs include angular velocity. As the disk flywheel approaches the first target speed, the mass bodies of the first mass inertia plate may move radially outward. Once the disk flywheel exceeds the first target speed, the first springs may be fully compressed and the first mass inertia plate may be disengaged from the disk flywheel as it may no longer efficiently accelerate the inertial mass of the disk flywheel. In response, the second mass inertia flywheel is engaged, and the second mass bodies may gradually move radially outward based on the angular velocity of the disk flywheel. The second mass inertia plate may be disengaged in response to the angular velocity of the flywheel plate exceeding a second target speed.

As another real-world example, during a braking event, the disk flywheel may be engaged with the second mass inertia plate if the disk flywheel angular velocity is between the second target speed and the first target speed. The second mass bodies may move radially inward via instruction from the controller to the second actuators to gradually adjust the moment of inertia. Once the first target speed is reached, the second mass inertia plate may be disengaged and the first mass inertia plate may be engaged, with the first mass bodies moving from radially outermost positions to radially inner positions. As such, in one example, a moment of inertia corresponding to the second mass bodies being in radially innermost positions of the second mass inertia plate and a moment of inertia corresponding to radially outermost positions of the first mass inertia plate may be the most similar moments of inertia between the first and second plates. By doing this, waste heat lost through frictional braking may be reduced, thereby increasing a longevity of frictional brakes and increasing energy recuperated through regenerative braking.

FIG. 8 shows a schematic depiction of a hybrid vehicle system 806 that can derive propulsion power from engine system 808 and/or an on-board energy storage device. Hybrid vehicle system 806 may be a non-limited example of the motor vehicle 13 of FIG. 7. An energy conversion device, such as a generator, may be operated to absorb energy from vehicle motion and/or engine operation, and then convert the absorbed energy to an energy form suitable for storage by the energy storage device.

Engine system 808 may include an engine 810 having a plurality of cylinders 830. Engine 810 includes an engine intake 823 and an engine exhaust 825. Engine intake 823 includes an air intake throttle 862 fluidly coupled to the engine intake manifold 844 via an intake passage 842. Air may enter intake passage 842 via air filter 852. Engine exhaust 825 includes an exhaust manifold 848 leading to an exhaust passage 835 that routes exhaust gas to the atmosphere. Engine exhaust 825 may include one or more emission control devices 870 mounted in a close-coupled or far vehicle underbody position. The one or more emission control devices may include a three-way catalyst, lean NOx trap, diesel particulate filter, oxidation catalyst, etc. It will be appreciated that other components may be included in the engine such as a variety of valves and sensors, as further elaborated in herein. In some embodiments, wherein engine system 808 is a boosted engine system, the engine system may further include a boosting device, such as a turbocharger (not shown).

Vehicle system 806 may further include control system 814. Control system 814 is shown receiving information from a plurality of sensors 816 (various examples of which are described herein) and sending control signals to a plurality of actuators 881 (various examples of which are described herein). As one example, sensors 816 may include exhaust gas sensor 126 located upstream of the emission control device, temperature sensor 128, and pressure sensor 129. Other sensors such as additional pressure, temperature, air/fuel ratio, and composition sensors may be coupled to various locations in the vehicle system 806. As another example, the actuators may include the throttle 862.

Controller 812 may be configured as a conventional microcomputer including a microprocessor unit, input/output ports, read-only memory, random access memory, keep alive memory, a controller area network (CAN) bus, etc. Controller 812 may be configured as a powertrain control module (PCM). The controller may be shifted between sleep and wake-up modes for additional energy efficiency. The controller may receive input data from the various sensors, process the input data, and trigger the actuators in response to the processed input data based on instruction or code programmed therein corresponding to one or more routines.

In some examples, hybrid vehicle 806 comprises multiple sources of torque available to one or more vehicle wheels 859. In other examples, vehicle 806 is a conventional vehicle with only an engine, or an electric vehicle with only electric machine(s). In the example shown, vehicle 806 includes engine 810 and an electric machine 851. Electric machine 851 may be a motor or a motor/generator. A crankshaft of engine 810 and electric machine 851 may be connected via a transmission 854 to vehicle wheels 859 when one or more clutches 856 are engaged. In the depicted example, a first clutch 856 is provided between a crankshaft and the electric machine 851, and a second clutch 856 is provided between electric machine 851 and transmission 854. Controller 812 may send a signal to an actuator of each clutch 856 to engage or disengage the clutch, so as to connect or disconnect crankshaft from electric machine 851 and the components connected thereto, and/or connect or disconnect electric machine 851 from transmission 854 and the components connected thereto. Transmission 854 may be a gearbox, a planetary gear system, or another type of transmission. The powertrain may be configured in various manners including as a parallel, a series, or a series-parallel hybrid vehicle.

Electric machine 851 receives electrical power from a traction battery 861 to provide torque to vehicle wheels 859. Electric machine 851 may also be operated as a generator to provide electrical power to charge battery 861, for example during a braking operation.

In one example, the controller 812 may comprise instructions that enable the controller 812 to adjust engagement and disengagement of the first mass plate (e.g., first mass plate 5 of FIGS. 3 and 4) and the second mass plate (e.g., second mass plate 6 of FIGS. 3 and 4) with the disc flywheel 1 (e.g., disc flywheel 1 of FIGS. 3 and 4). The instructions may enable the controller to adjust engagement or disengagement in response to one or more inputs, including a disc flywheel velocity, which may include an angular velocity and/or a rotational velocity, a plurality of spring constants of the first springs of the first mass plate and the second springs of the second mass plates, a mass of the first mass bodies of the first mass plate and a mass of the second mass bodies of the second mass plate, and radial positions of the first mass bodies and the second mass bodies. Based on these inputs, an algorithm may determine a desired moment of inertia, wherein the controller may flow hydraulic fluid or may activate an electromagnetic device to engage one of the first or second mass plates to achieve the desired moment of inertia to provide smooth vehicle operation with increased power during an acceleration and reduced fuel economy or increased energy recuperation during a braking event.

The instructions may further enable the controller to adjust the mass bodies of the first mass plate and the second mass plate through a full radial range, if desired, to achieve a plurality of moments of inertia. By realizing a greater range of moments of inertia, engine power output and fuel economy may be increased during an acceleration and energy recovery may be increased during a deceleration due to less energy being lost as waste heat due to frictional braking.

In one example, as the flywheel is accelerating due to a braking event, the controller may engage only the second mass plate, wherein the second mass bodies of the second mass plate are signaled to gradually move radially inward as the moment of inertia of the disc flywheel decreases. Once a frictional connection between the flywheel and the second mass plate dissolves, the second mass plate may be disengaged and the first mass plate may be engaged.

In one example, the flywheel comprises actuators that may selectively actuate the first and second mass bodies of the first and second inertia plates. The controller may comprise instructions stored on non-transitory memory thereof that enable the controller to activate the actuators to move the mass of an engaged inertia plate towards an outer radial position as the engine accelerates. For example, if the first mass inertia plate is engaged to the disk flywheel, then the controller may signal to first actuators of the first plate to actuate the first mass bodies radially outward with a centrifugal force against a force of the first springs to gradually increase the moment of inertia from a lower moment of inertia. Once a first target speed is reached, the first mass inertia plate may be decoupled from the disk flywheel, and the second mass plate may be engaged wherein the second mass bodies are gradually moved to radially outer positions to continue increasing the moment of inertia. In this way, the moments of inertia achieved by the second mass inertia plate are greater than those of the first mass inertia plate. Once a second target speed is reached, the second mass inertia plate may be decoupled from the disk flywheel. Activating the actuators may include flowing hydraulic fluid thereto or powering an electromagnet therein.

In this way, a flywheel may comprise a disc flywheel with a first mass plate and a second mass plate, the first and second mass plates selectively engageable to the disc flywheel. The technical effect of rotatably mounting at least two mass plates, each with its own plurality of weights, is to provide a graded moment of inertia to the flywheel to increase fuel economy and driver comfort.

An embodiment of a flywheel comprises a rotational axis, at least one disk flywheel and at least two inertial mass rings which are arranged radially offset with respect to one another and are rotatably mounted, wherein for each inertial mass ring a number of braking apparatuses are connected to the disk flywheel, wherein the braking apparatuses are configured for a detachable connection to the inertial mass ring.

A first example of the flywheel further includes where the braking apparatuses comprise in each case at least one brake pad, at least one spring and at least one mass body and the detachable connection to the inertial mass ring is brought about in the form of a frictionally engaged connection in that at least one mass body pushes the at least one brake pad against the inertial mass ring via the at least one spring, wherein in each case the at least one mass body is arranged radially displaceably against the spring so that the spring is compressed as a function of the rotational speed of the disk flywheel and the frictionally engaged connection is detached as a result.

A second example of the flywheel, optionally including the first example, further includes where at least one inertial mass ring comprises a circumferential surface and the braking apparatuses are arranged so that they are pushed via the springs radially from the outside against the circumferential surface of the inertial mass ring.

A third example of the flywheel, optionally including one or more of the previous examples, further includes where a first inertial mass ring can be connected in a frictionally engaged manner to a number of braking apparatuses which comprise in each case mass bodies with a first mass m₁, and a second inertial mass ring can be connected in a frictionally engaged manner to a number of braking apparatuses which comprise in each case mass bodies with a second mass m₂wherein mass m₁ differs from mass m₂.

A fourth example of the flywheel, optionally including one or more of the previous examples, further includes where a first inertial mass ring can be connected in a frictionally engaged manner to a number of braking apparatuses which comprise in each case springs with a first spring constant D₁, and a second inertial mass ring can be connected in a frictionally engaged manner to a number of braking apparatuses which comprise in each case springs with a second spring constant D₂, wherein spring constant D₁ differs from spring constant D₂.

A fifth example of the flywheel, optionally including one or more of the previous examples, further includes where the flywheel comprises more than two inertial mass rings which are arranged radially offset with respect to one another, are rotatably mounted and can be connected in each case in a frictionally engaged manner to a number of braking apparatuses assigned to each inertial mass ring, wherein the braking apparatuses assigned to each inertial mass ring have mass bodies with an individual mass mi which differ from individual masses mj of the mass bodies of the braking apparatuses assigned to the other inertial mass rings (mi≠mj).

A sixth example of the flywheel, optionally including one or more of the previous examples, further includes where the flywheel comprises more than two inertial mass rings which are arranged radially offset with respect to one another, are rotatably mounted and can be connected in each case in a frictionally engaged manner to a number of braking apparatuses, wherein the braking apparatuses assigned to each inertial mass ring have springs with an individual spring constant Di for each inertial mass ring which differ from individual spring constant Dj of the springs of the braking apparatuses assigned to the other inertial mass rings (Di≠Dj).

A seventh example of the flywheel, optionally including one or more of the previous examples, further includes where the braking apparatuses comprise in each case at least one mass body and the detachable connection to the inertial mass ring is brought about in the form of a frictionally engaged connection in that at least one mass body pushes a brake pad against the inertial mass ring via a spring fastened to the disk flywheel, wherein in each case the at least one mass body is arranged radially displaceably against the spring via an actuator so that the spring is compressed by the mass body and the frictionally engaged connection is detached as a result.

An eighth example of the flywheel, optionally including one or more of the previous examples, further includes where the actuator is configured to be hydraulically controllable.

A ninth example of the flywheel, optionally including one or more of the previous examples, further includes where at least one inertial mass ring can be connected electromagnetically to the braking apparatuses.

A tenth example of the flywheel, optionally including one or more of the previous examples, further includes where the flywheel is included in a recuperation arrangement

An eleventh example of the flywheel, optionally including one or more of the previous examples, further includes where the flywheel is arranged in a drive arrangement

A twelfth example of the flywheel, optionally including one or more of the previous examples, further includes where the drive arrangement configured as a motor vehicle or ship.

A thirteenth example of the flywheel, optionally including one or more of the previous examples, further includes where the motor vehicle is configured as a hybrid motor vehicle.

A flywheel, comprising:

a disk flywheel and at least two inertial mass rings, including a first mass ring and a second mass ring arranged radially offset with respect to one another and are rotatably mounted and rotate around a rotation axis, further comprising a first braking apparatus for selectively coupling the first mass ring to the disk flywheel and a second braking apparatus for selectively coupling the second mass ring to the disk flywheel.

A first example of the flywheel, optionally includes where the first braking apparatus comprises a first brake pad, a first mass body, and a first spring, wherein the first mass body pushes the first brake pad against the first mass ring via the first spring, and wherein the first mass body is radially displaceable against the first spring as a function of at least a rotational speed of the disk flywheel

A second example of the flywheel, optionally including the first example, further includes where the second braking apparatus comprises a second brake pad, a second mass body, and a second spring, wherein the second mass body pushes the second brake pad against the second mass ring via the second spring, and wherein the second mass body is radially displaceable against the second spring as a function of at least the rotational speed of the disk flywheel

A third example of the flywheel, optionally including one or more of the previous examples, further includes where the first mass ring comprises a first circumferential surface and the second mass ring comprises a second circumferential surface, a circumference of the second circumferential surface being greater than a circumference of the first circumferential surface, wherein the first braking apparatus is arranged to push against the first circumferential surface and the second braking apparatus is arranged to push against the second circumferential surface.

A fourth example of the flywheel, optionally including one or more of the previous examples, further includes where the first mass body comprises a first mass m₁ and the second mass body comprises a second mass m₂, wherein mass m₁ differs from mass m₂.

A fifth example of the flywheel, optionally including one or more of the previous examples, further includes where the first spring comprises a first spring constant D₁ and the second spring comprises a second spring constant D₂, wherein spring constant D₁ differs from spring constant D₂.

A sixth example of the flywheel, optionally including one or more of the previous examples, further includes where the second mass body is arranged radially outside of the first mass body.

A seventh example of the flywheel, optionally including one or more of the previous examples, further includes where the first mass plate comprises a first actuator configured to press the first mass body against a force of the first spring in a radially outward direction.

An eighth example of the flywheel, optionally including one or more of the previous examples, further includes where the second mass plate comprises a second actuator configured to press the second mass body against a force of the second spring in a radially outward direction.

A ninth example of the flywheel, optionally including one or more of the previous examples, further includes where the first mass plate is decoupled from the disk flywheel in response to the first spring being fully compressed, and wherein the second mass plate is decoupled from the disk flywheel in response to the second spring being fully compressed.

An embodiment of a system comprises a flywheel rotatably arranged about an axis of rotation, a first mass plate rotatably arranged about the axis of rotation and configured to selectively frictionally engage with the flywheel, and a second mass plate rotatably arranged about the axis of rotation and configured to frictionally engage with the flywheel, the second mass plate concentric with the first mass plate about the axis of rotation.

A first example of the system further includes where the first mass plate comprises a plurality of first mass bodies coupled to a plurality of first springs, wherein each mass body of the plurality of first mass bodies comprises a first mass and wherein each spring of the plurality of first springs comprises a first spring constant, and wherein the second mass plate comprises a plurality of second mass bodies coupled to a plurality of second springs, wherein each mass body of the plurality of second mass bodies comprises a second mass and wherein each spring of the plurality of second springs comprises a second spring constant, wherein the second mass is different than the first mass and the second spring constant is different than the first spring constant.

A second example of the system, optionally including the first example, further includes where the plurality of first mass bodies are symmetrically arranged relative to the axis of rotation, the plurality of first mass bodies configured to press against an outer circumference of the first mass plate.

A third example of the system, optionally including one or more of the previous examples, further includes where the plurality of second mass bodies are symmetrically arranged relative to the axis of rotation, the plurality of second mass bodies configured to press against an outer circumference of the second mass plate.

A fourth example of the system, optionally including one or more of the previous examples, further includes where the first mass bodies are positioned more radially inward than the second mass bodies.

A fifth example of the system, optionally including one or more of the previous examples, further includes where the plurality of first mass bodies comprises a plurality of first actuators, wherein each actuator of the plurality of first actuators is configured to actuate one first mass body of the plurality of first mass bodies.

A sixth example of the system, optionally including one or more of the previous examples, further includes where the plurality of second mass bodies comprises a plurality of second actuators, wherein each actuator of the plurality of second actuators is configured to actuate one second mass body of the plurality of second mass bodies.

A seventh example of the system, optionally including one or more of the previous examples, further includes where the plurality of first actuators and the plurality of second actuators are electromagnetic.

An embodiment of a hybrid vehicle comprises an engine, an electric motor, a battery, a flywheel selectively engageable to a first mass inertia plate and a second mass inertia plate, wherein the first mass inertia plate comprises a plurality of first mass bodies symmetrically arranged about the first mass inertia plate relative to an axis of rotation, and wherein the second mass inertia plate comprises a plurality of second mass bodies symmetrically arranged about the second mass inertia plate relative to the axis of rotation, wherein the second mass inertia plate comprises a circumference greater than a circumference of the first mass inertia plate, and a controller with computer-readable instructions stored on non-transitory memory thereof that when executed enable the controller to activate a plurality of first actuators to engage the first mass inertia plate to a flywheel disk, deactivate the plurality of first actuators to disengage the first mass inertia plate from the flywheel disk in response to a rotational speed of the flywheel disk exceeding a first target speed, activate a plurality of second actuators to engage the second mass inertia plate to the flywheel disk and deactivate the plurality of second actuators to disengage the second mass inertia plate from the flywheel disk in response to the rotational speed of the flywheel disk exceeding a second target speed, the second target speed being greater than the first.

A first example of the hybrid vehicle further includes where the first mass inertia plate and the second mass inertia plate are engaged to the flywheel disk in response to a braking event and an engine starting event.

Note that the example control and estimation routines included herein can be used with various engine and/or vehicle system configurations. The control methods and routines disclosed herein may be stored as executable instructions in non-transitory memory and may be carried not by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the other of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the terms “approximately” and “substantially” are construed to mean plus or minus five percent of the range unless otherwise specified.

The following claims particularly point out certain combinations and sub-combinations regarded as novel and non-obvious. The claims may refer to “an” element or “a first” element of the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal or different in scope to the original claims, also are regarded as included within the subject matter of the present disclosure.

1. A flywheel, comprising:
a disk flywheel and at least two inertial mass rings, including a first mass ring and a second mass ring arranged radially offset with respect to one another and are rotatably mounted and rotate around a rotation axis, further comprising a first braking apparatus for selectively coupling the first mass ring to the disk flywheel and a second braking apparatus for selectively coupling the second mass ring to the disk flywheel.

2. The flywheel of claim 1, wherein the first braking apparatus comprises a first brake pad, a first mass body, and a first spring, wherein the first mass body pushes the first brake pad against the first mass ring via the first spring, and wherein the first mass body is radially displaceable against the first spring as a function of at least a rotational speed of the disk flywheel.

3. The flywheel of claim 2, wherein the second braking apparatus comprises a second brake pad, a second mass body, and a second spring, wherein the second mass body pushes the second brake pad against the second mass ring via the second spring, and wherein the second mass body is radially displaceable against the second spring as a function of at least the rotational speed of the disk flywheel.

4. The flywheel as claimed in claim 3, wherein the first mass ring comprises a first circumferential surface and the second mass ring comprises a second circumferential surface, a circumference of the second circumferential surface being greater than a circumference of the first circumferential surface, wherein the first braking apparatus is arranged to push against the first circumferential surface and the second braking apparatus is arranged to push against the second circumferential surface.

5. The flywheel of claim 3, wherein the first mass body comprises a first mass m₁ and the second mass body comprises a second mass m₂, wherein mass m₁ differs from mass m₂.

6. The flywheel of claim 3, wherein the first spring comprises a first spring constant D₁ and the second spring comprises a second spring constant D₂, wherein spring constant D₁ differs from spring constant D₂.

7. The flywheel of claim 3, wherein the second mass body is arranged radially outside of the first mass body.

8. The flywheel of claim 3, wherein the first mass plate comprises a first actuator configured to press the first mass body against a force of the first spring in a radially outward direction.

9. The flywheel of claim 8, wherein the second mass plate comprises a second actuator configured to press the second mass body against a force of the second spring in a radially outward direction.

10. The flywheel of claim 3, wherein the first mass plate is decoupled from the disk flywheel in response to the first spring being fully compressed, and wherein the second mass plate is decoupled from the disk flywheel in response to the second spring being fully compressed.

11. A system, comprising:
a flywheel rotatably arranged about an axis of rotation;
a first mass plate rotatably arranged about the axis of rotation and configured to selectively frictionally engage with the flywheel; and
a second mass plate rotatably arranged about the axis of rotation and configured to frictionally engage with the flywheel, the second mass plate concentric with the first mass plate about the axis of rotation.

12. The system of claim 11, wherein the first mass plate comprises a plurality of first mass bodies coupled to a plurality of first springs, wherein each mass body of the plurality of first mass bodies comprises a first mass and wherein each spring of the plurality of first springs comprises a first spring constant, and wherein the second mass plate comprises a plurality of second mass bodies coupled to a plurality of second springs, wherein each mass body of the plurality of second mass bodies comprises a second mass and wherein each spring of the plurality of second springs comprises a second spring constant, wherein the second mass is different than the first mass and the second spring constant is different than the first spring constant.

13. The system of claim 12, wherein the plurality of first mass bodies are symmetrically arranged relative to the axis of rotation, the plurality of first mass bodies configured to press against an outer circumference of the first mass plate.

14. The system of claim 13, wherein the plurality of second mass bodies are symmetrically arranged relative to the axis of rotation, the plurality of second mass bodies configured to press against an outer circumference of the second mass plate.

15. The system of claim 14, wherein the first mass bodies are positioned more radially inward than the second mass bodies.

16. The system of claim 13, wherein the plurality of first mass bodies comprises a plurality of first actuators, wherein each actuator of the plurality of first actuators is configured to actuate one first mass body of the plurality of first mass bodies.

17. The system of claim 16, wherein the plurality of second mass bodies comprises a plurality of second actuators, wherein each actuator of the plurality of second actuators is configured to actuate one second mass body of the plurality of second mass bodies.

18. The system of claim 17, wherein the plurality of first actuators and the plurality of second actuators are electromagnetic.

19. A hybrid vehicle, comprising:
an engine;
an electric motor;
a battery;
a flywheel selectively engageable to a first mass inertia plate and a second mass inertia plate, wherein the first mass inertia plate comprises a plurality of first mass bodies symmetrically arranged about the first mass inertia plate relative to an axis of rotation, and wherein the second mass inertia plate comprises a plurality of second mass bodies symmetrically arranged about the second mass inertia plate relative to the axis of rotation, wherein the second mass inertia plate comprises a circumference greater than a circumference of the first mass inertia plate; and
a controller with computer-readable instructions stored on non-transitory memory thereof that when executed enable the controller to:
activate a plurality of first actuators to engage the first mass inertia plate to a flywheel disk;
deactivate the plurality of first actuators to disengage the first mass inertia plate from the flywheel disk in response to a rotational speed of the flywheel disk exceeding a first target speed;
activate a plurality of second actuators to engage the second mass inertia plate to the flywheel disk; and
deactivate the plurality of second actuators to disengage the second mass inertia plate from the flywheel disk in response to the rotational speed of the flywheel disk exceeding a second target speed, the second target speed being greater than the first.

20. The hybrid vehicle of claim 19, wherein the first mass inertia plate and the second mass inertia plate are engaged to the flywheel disk in response to a braking event and an engine starting event.
